(19) United States
(12) Patent Application Publication
(10) Pub. No.: US 2008/0160196 A1
(43) Pub. Date: Jul. 3, 2008

(54) APPARATUS AND METHOD OF FORMING PATTERN USING INKJET PRINTING AND NANO IMPRINTING

(75) Inventors: Woo-sik KIM, Yongin-si (KR); Seong-jin Kim, Yongin-si (KR); Seung-joo Shin, Yongin-si (KR); Tae-woon Cha, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/772,509

(22) Filed: Jul. 2, 2007

(30) Foreign Application Priority Data
Jan. 3, 2007 (KR) 2007-702

(51) Int. Cl. B41J 29/38

(52) U.S. Cl. 427/282; 347/9

(57) ABSTRACT

An apparatus and method of forming a pattern using an inkjet printing method and nano imprinting method. The method includes partially inkjet printing a material for forming the pattern on a surface of the substrate using an inkjet head, and forming a predetermined pattern by imprinting the inkjet printed material on the surface of the substrate using an imprint mold. The method also includes partially inkjet printing a material for forming the pattern in an imprint mold using an inkjet head, and forming a predetermined pattern by imprinting the material on a surface of the substrate using the imprint mold. During the partial inkjet printing, at least two materials that are different from each other are inkjet printed on different locations of the surface of the substrate.

### CROSS-REFERENCE TO RELATED APPLICATIONS

This application claims the benefit of Korean Patent Application No. 10-2007-0000702, filed on Jan. 3, 2007, in the Korean Intellectual Property Office, the disclosure of which is incorporated herein in its entirety by reference.

### BACKGROUND OF THE INVENTION

1. Field of the Invention

The present general inventive concept relates to an apparatus and method of forming a pattern, and more particularly, to an apparatus and method of forming a pattern using inkjet printing and nano imprinting.

2. Description of the Related Art

Inkjet heads are devices for printing a predetermined color image by ejecting minute droplets of ink on desired areas of a printing medium. The application of the inkjet head has expanded for flat panel displays such as a liquid crystal display (LCD), an organic light emitting diode (OLED), and a plasma display panel (PDP), printed circuit boards that include metal wirings and resistances, and semiconductor packagings.

However, when a predetermined image or a pattern is formed using the inkjet head, there is a limit of resolution that can be achieved in forming a pattern. More specifically, when an inkjet printing method is used for forming a pattern, it is difficult to realize a resolution of 10 μm or less even when in a laboratory, and it is known that a maximum resolution that can be achieved in an actual production site is approximately 50 μm.

Recently, a nano imprinting method has been used as a method of forming a pattern having a resolution of less than a few hundreds of nanometers. In the nano imprinting method, a predetermined material pattern is formed on a substrate by transferring a pattern using a mold on which the pattern is already formed.

FIGS. 1A through 1E are cross-sectional views illustrating a conventional nono imprinting method of forming a pattern to show problems thereof.

Referring to FIG. 1A, a substrate 10 and an imprint mold 20 having a pre-pattern are prepared. As depicted in FIG. 1B, a material 12 for forming the pattern is coated on the substrate 10. At this point, the material 12 can be a thermo-setting material or an ultraviolet (UV) ray setting material according to a method of hardening the material 12. The material 12 is coated on a surface of the substrate 10 to a uniform thickness using a spin coating method.

Then, as depicted in FIG. 1C, the material 12 coated on the substrate 10 is pressed using the imprint mold 20. Then, the material 12 is hardened by irradiating UV rays or applying heat to the material 12, and then, the imprint mold 20 is removed

As a result, as depicted in FIG. 1D, a pattern 15 formed of the material 12 is formed on the surface of the substrate 10, and a residual film 17 formed of the material 12 is formed around the pattern 15.

However, in the conventional imprinting process, the thickness of the residual film 17 remaining around the pattern 15 is non-uniform due to the fact that the material 12 coated on the surface of the substrate 10 has an uniform thickness. Hence, the material 12 coated on the surface of the substrate 10 where the pattern 15 is not formed remains as a thick residual film 17.

Accordingly, in the end of the imprinting process, the residual film 17 must be removed by ashing or etching. If all of the residual film 17 is removed, as depicted in FIG. 1E, the thickness of the pattern 15 finally remaining on the substrate 10 can partly be very thin or, in a worst case, portions of the pattern 15 are completely removed together with the residual film 17. This problem becomes severer as the surface of the substrate 10 increases.

### SUMMARY OF THE INVENTION

The present general inventive concept provides an apparatus and method of forming a pattern in which a residual film can be formed to a uniform thickness by using an inkjet printing method and a nano imprinting method.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of forming a pattern, the method including partially inkjet printing a material for forming the pattern on a surface of the substrate using an inkjet head, and forming a predetermined pattern by imprinting the inkjet printed material on the surface of the substrate using an imprint mold.

During the partial inkjet printing, a quantity and/or a width of the material that are inkjet printed may be different according to locations on the surface of the substrate where the material is to be inkjet printed.

During the partial inkjet printing, at least two materials that are different from each other may be inkjet printed on different locations of the surface of the substrate.

The forming of the predetermined pattern by imprinting the inkjet printed material on the surface of the substrate using an imprint mold may comprise filling the inkjet printed material on the surface of the substrate in concaved grooves of the imprint mold by pressing the imprint mold against the substrate, forming the pattern by hardening the material, and removing a residual film around the pattern.

The material may be hardened by irradiating ultraviolet rays or applying heat.

The foregoing and/or other aspects and utilities of the present general inventive concept may also be achieved by providing a method of forming a pattern, the method including partially inkjet printing a material for forming the pattern in an imprint mold using an inkjet head, and forming a predetermined pattern by imprinting the material on a surface of the substrate using the imprint mold.

During the partial inkjet printing, the material may be partially filled in the concaved grooves in the pattern of the imprint mold.

During the partial inkjet printing, at least two materials that are different from each other may be inkjet printed on different locations of the imprint mold.

The forming of the predetermined pattern by imprinting the material on the surface of the substrate using the imprint mold may include attaching the material inkjet printed in concaved grooves of the imprint mold to the surface of the substrate by pressing the imprint mold against the substrate, forming the pattern by hardening the material, and removing a residual film around the pattern.

The foregoing and/or other aspects and utilities of the present general inventive concept may also be achieved by providing a method of forming a pattern, the method including partially inkjet printing a material on a reference surface using an inkjet head, and forming a predetermined pattern by imprinting the partially inkjet printed material on a surface of a substrate using an imprint mold.

The reference surface may be a surface of the substrate.

The reference surface may be a surface of the imprint mold, and may be concave grooves of the imprint mold.

The reference surface may include a first surface and a second surface, and the material may include a first material formed in the first surface and a second material formed in the second surface.

The reference surface may include a flat surface.

The partially inkjet printed material may include a plurality of portions spaced-apart from each other to correspond to the pattern.

The partially inkjet printed material may include a plurality of portions having different dimensions to correspond to a shape of the pattern.

The foregoing and/or other aspects and utilities of the present general inventive concept may also be achieved by providing a method of forming a pattern, the method including forming a predetermined pattern by imprinting the partially inkjet printed material formed on a reference surface, on a substrate using an imprint mold.

The partially inkjet printed material may not be a single body on within the reference surface.

The partially inkjet printed material may include portions separated from each other by a distance within the reference surface.

The partially inkjet printed material may include a portion and different portions separated from the portion by a distance within the reference surface.

The partially inkjet printed material may include portions having different dimensions from each other within the reference surface.

The pattern may include a first pattern, a second pattern spaced-apart from the first pattern by a first distance, a third pattern spaced apart from the second pattern by a second distance, and a fourth pattern spaced-apart from the third pattern by a third distance.

The partially inkjet printed material may include a first portion to correspond to the first pattern, a second portion spaced apart from the first portion to correspond to the second pattern, and a third portion to correspond to the third pattern and the fourth pattern.

The foregoing and/or other aspects and utilities of the present general inventive concept may also be achieved by providing a method of forming a pattern, the method including imprinting a material having partial portions spaced-apart from each other to form a pattern on a substrate using an imprint mold.

The foregoing and/or other aspects and utilities of the present general inventive concept may also be achieved by providing a method of forming a pattern, the method including imprinting a first material and a second material spaced-apart from each other on a reference surface to form a pattern on a substrate using an imprint mold.

The foregoing and/or other aspects and utilities of the present general inventive concept may also be achieved by providing an apparatus to form a pattern, the apparatus including an inkjet head to partially inkjet print a material to form the pattern, on a reference surface, and a unit having a substrate and an imprint mold to form a predetermined pattern by imprinting the inkjet printed material of the reference surface on the substrate using the imprint mold.

The apparatus may further include a controller to control the inkjet head to form the partially inkjet printed material on the reference surface according to the pattern.

The apparatus may further include a memory to store information on a plurality of locations of the reference surface to correspond to a shape of the pattern, and a controller to control the inkjet head to eject the material on the stored locations of the reference surface.

The material may include a plurality of materials; and the inkjet head comprises a plurality of heads to eject corresponding ones of the plurality of materials on the reference surface.

The inkjet head may form a first portion of the material at a first location of the reference surface and a second portion of the material at a second location of the reference surface.

### BRIEF DESCRIPTION OF THE DRAWINGS

The above and other aspects and utilities of the present general inventive concept will become more apparent by describing in detail exemplary embodiments thereof with reference to the attached drawings in which:

FIGS. 1A through 1E are cross-sectional views illustrating a method of forming a pattern using a conventional nano imprinting method to show problems thereof;

FIGS. 2A through 2E are cross-sectional views illustrating a method of forming a pattern using an inkjet printing method and a nano imprinting method, according to an embodiment of the present general inventive concept;

FIG. 3 is a cross-sectional view illustrating a method of forming a pattern according to an embodiment of the present general inventive concept;

FIGS. 4A through 4C are cross-sectional views illustrating a method of forming a pattern according to an embodiment of the present general inventive concept; and

FIG. 5 is a view illustrating an apparatus to form a pattern according to an embodiment of the present general inventive concept.

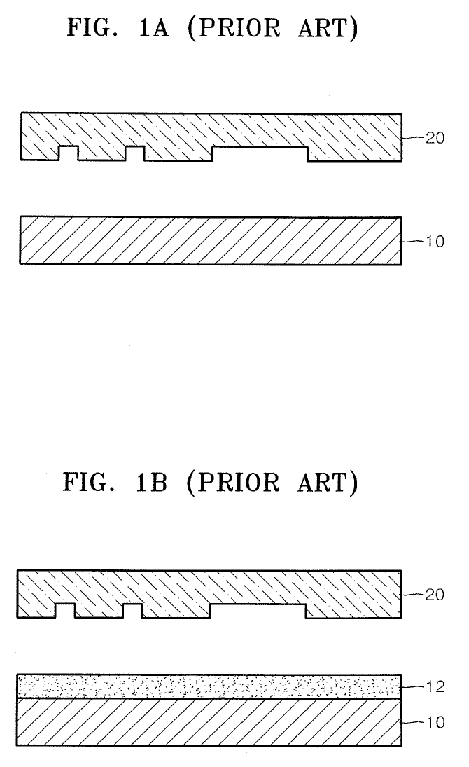

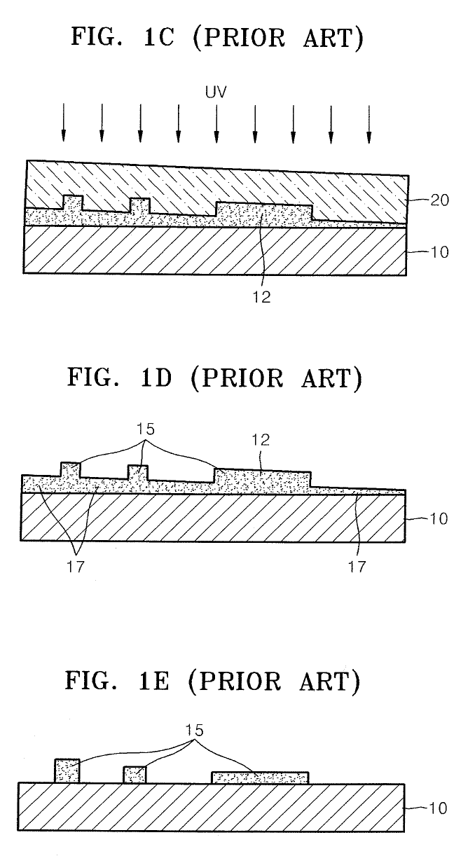

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

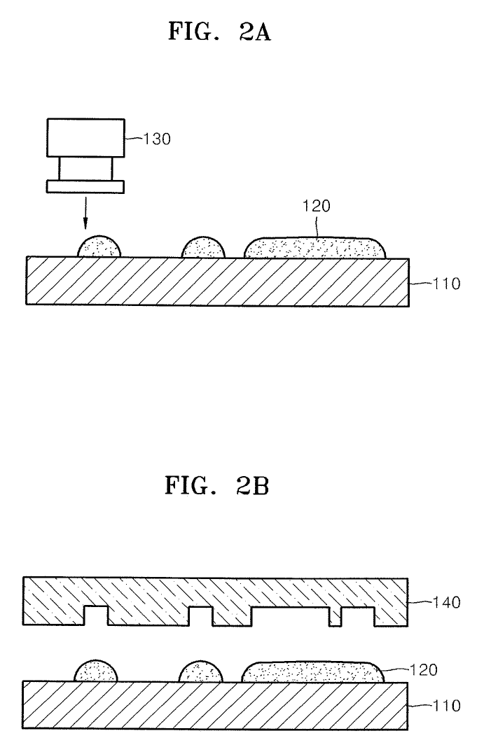

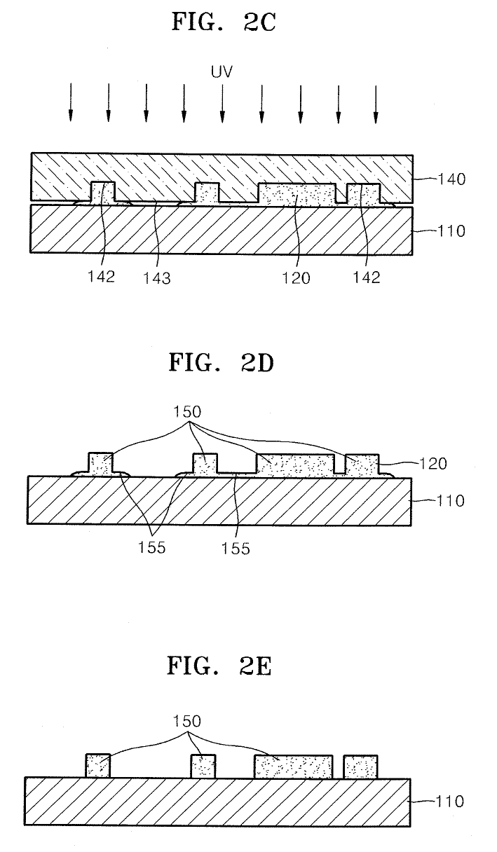

FIGS. 2A through 2E are cross-sectional views illustrating a method of forming a pattern 150 using an inkjet printing apparatus and method and/or a nano imprinting apparatus and method, according to an embodiment of the present general inventive concept.

Referring to FIG. 2A, after a substrate 110 is prepared, a material 120 to form a pattern is coated on a reference surface, such as the substrate 110. At this point, the substrate 110 can be a silicon wafer, a metal plate, a glass substrate, or a plastic substrate. If the material 120 is used to make an etch mask having a predetermined pattern to etch the substrate 110 under the material 120, the material 120 can be a resin. If the material 120 is used to form a metal wire having a predetermined pattern on the substrate 110, the material 120 can be a material containing a metal for forming the metal wire. The material 120 can be a thermosetting material or a ultra-violet (UV) setting material depending on a method of hardening the material 120 as described later.

A characteristic of the material 120 can be selected or determined to form a desirable pattern on an LCD, an OLED, a PDP, a printed circuit board (PCB), a semiconductor packing, etc.

In the present embodiment, the material 120 is coated by an inkjet printing method using an inkjet head 130. If the inkjet printing method is used to coat the material 120, the material 120 can be partly coated on the surface of the substrate 110 according to a desired pattern without having to coat the entire surface of the substrate 110 with the material 120. Thus, on portions of the surface of the substrate 110, a large amount of the material 120 can be coated, and other portions of the surface of the substrate 110, a small amount of the material 120 can be coated with a narrow width.

That is, the material 120 formed on the substrate 110 is determined according to a characteristic of the pattern to be formed. For example, if a portion of a pattern has a narrow dimension or size in cross-section, a portion of the material has a dimension or size to correspond to the portion of the pattern.

Then, referring to FIG. 2B, an imprint mold 140 on which a desired pattern is formed is placed above the substrate 110.

Referring to FIG. 2C, if the imprint mold 140 having concave grooves 142 and surfaces 143 disposed between the adjacent concave grooves 142 is pressed against the substrate 110, the material 120 coated on a reference surface of the substrate 110 fills the concaved grooves 142 of the desired pattern of the imprint mold 140. At this point, since the material 120 is coated on locations of the substrate 110 where the pattern will be formed, most of the material 120 is filled into the concaved grooves 142 of the imprint mold 140. Accordingly, the material 120 remaining between the protruding surface of the imprint mold 140 and the substrate 110 is very small, and thus, a gap between the protruding surface of the imprint mold 140 and the substrate 110 is very small as compared to the conventional imprinting method.

The material 120 is hardened by irradiating UV rays or applying heat according to the properties of the material 120. Afterwards, the imprint mold 140 is removed.

Referring to FIG. 2D, the pattern 150 is formed on the surface of the substrate 110 using the material 120, and a residual film 155 having a thin and uniform thickness as compared to the prior art is formed around the pattern 150.

Finally, the residual film 155 is removed by ashing or etching. At this point, a slight portion of the pattern 150 is also removed when the residual film 155 is removed. As a result, the residual film 155 is completely removed and the pattern 150 remains on the substrate 110.

As described above, according to the present invention, since the residual film 155 remaining around the pattern 150 has a very thin and uniform thickness in the course of forming the pattern 150, a damage to the pattern 150 during the removing of the residual film 155 or excessive loss to the thickness of the pattern 150, as happens in the prior art, can be prevented. In particular, even if the surface of the substrate 110 is large, the residual film 155 having a very thin and uniform thickness remains. Although, when the inkjet printing method is used, a pattern having a high resolution cannot be realized, however, if the inkjet printing method and a nano imprinting method are performed at the same time, a pattern having a high resolution can be realized.

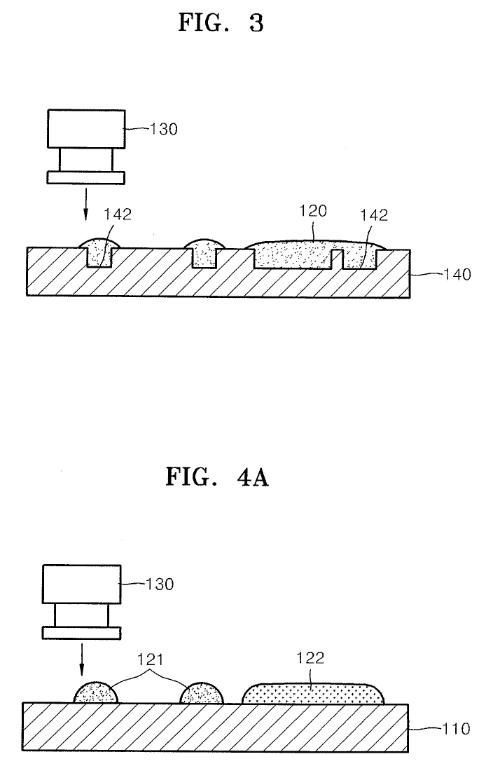

FIG. 3 is a cross-sectional view illustrating a method of forming a pattern 150 according to an embodiment of the present general inventive concept.

Referring to FIG. 3, the material 120 to form the pattern 150 is coated on a reference surface, that is, the imprint mold 140 instead of the surface of the substrate 110. Also, in this case, the coating of the material 120 is performed by using the inkjet printing method using the inkjet head 130. More specifically, the material 120 is partly coated to fill the concave grooves 142 of the pattern of the imprint mold 140.

As described above, the imprint mold 140 on which the material 120 is coated is pressed against the substrate 110 so that the material 120 can be attached to the surface of the substrate 110.

Subsequent processes are the same as the processes described with reference to FIGS. 2C through 2E, and thus, their descriptions will not be repeated.

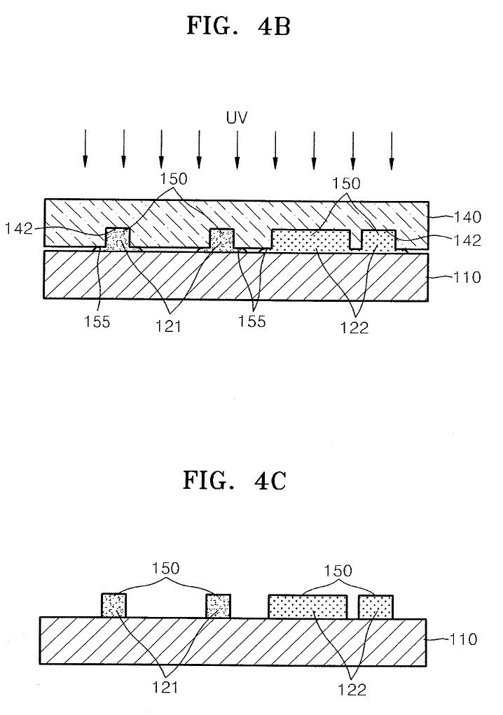

FIGS. 4A through 4C are cross-sectional views of a method of forming the pattern 150 according to another embodiment of the present invention. The method of forming the pattern 150 according to the present embodiment is similar to the methods of forming the pattern 150 described with reference to FIGS. 2A through 2E and 3. However, in the previous embodiments, the pattern 150 is formed using a single material 120, however, in the present embodiment, the pattern 150 is formed using more than two materials 121 and 122 that are different from each other.

In this case, the inkjet head 130 may include a plurality of heads to store a plurality of materials and to eject corresponding ones of the plurality of materials on a reference surface, for example, one of the substrate 110 and the imprint mold 140.

Referring to FIG. 4A, the two materials 121 and 122, which are different from each other, are coated on different locations on the surface of the substrate 110 by using an inkjet printing method that uses the inkjet head 130. However, when the inkjet printing method is used, more than three materials that are different from each other can be coated on locations on the surface of the substrate 110.

Referring to FIG. 4B, the imprint mold 140 on which the pattern 150 is formed is pressed against the substrate 110. Afterwards, the two materials 121 and 122, which fill into the concaved grooves 142 of the pattern of the imprint mold 140, are hardened by irradiating UV rays or applying heat. The imprint mold 140 is removed and the residual film 155 around the pattern 150 is removed.

Hence, as depicted in FIG. 4C, the pattern 150 formed of different materials from each other on different locations of the surface of the substrate 110 is formed.

The method of forming a pattern according to the present embodiment described with reference to FIGS. 4A through 4C can also be applied to the embodiment described with reference to FIG. 3. Hence, the two materials 121 and 122 that are different from each other can be imprinted on the substrate 110 according to the locations of the pattern of the imprint mold 140.

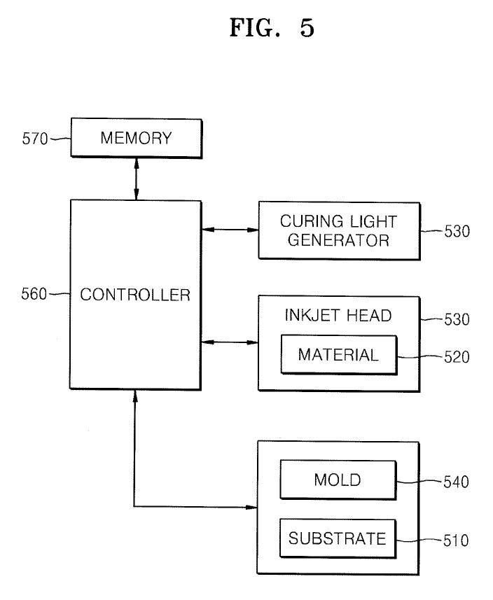

FIG. 5 is a view illustrating an apparatus to form a pattern according to an embodiment of the present general inventive concept. Referring to FIGS. 2A through 5, the apparatus includes a unit having a substrate 510 and an imprint mold 540, an inkjet head 530 having one or more heads to contain corresponding ones of one or more materials 520 to eject the contained materials, a memory 570 to store information on the pattern, and a controller 560 to controller components of the apparatus. The apparatus of FIG. 5 may perform the methods described in FIGS. 2A through 4C. It is possible that the memory 570 stores the information on one or more locations of the reference surface to correspond to a shape of the pattern. The one or more locations may include a portion and different portions extended from the portion or separated from the portion, and the material includes one or more materials to be formed on corresponding locations. The one or more materials may be same, or different from each other. The controller 56 may control the inkjet head 530 to form the material on the one or more locations according to the information. The substrate 510 is formed with the pattern using the mold 540 and the material 520 ejected and formed by the inkjet head 530.

As described above, according to the present general inventive concept, since a residual film remaining around a pattern has a very thin and uniform thickness during the forming of the pattern, the damage to the pattern and the excessive loss of thickness of the pattern during a process of removing the residual film can be prevented. If only the inkjet printing method is used, a pattern having a high resolution cannot be realized, however, the inkjet printing method and a nano imprinting method are used at the same time, and thereby, realizing a pattern having a high resolution. According to the present general inventive concept, a pattern formed of different materials from each other on different locations of the surface of the substrate can be formed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of forming a pattern, the method comprising:
partially inkjet printing a material for forming the pattern on a surface of the substrate using an inkjet head; and
forming a predetermined pattern by imprinting the inkjet printed material on the surface of the substrate using an imprint mold.

2. The method of claim 1, wherein the partial inkjet printing of the material comprises controlling at least one of a quantity and a width of the material that is inkjet printed to be different according to locations on the surface of the substrate where the material is to be inkjet printed.

3. The method of claim 1, wherein the partial inkjet printing of the material comprises inkjet printing at least two materials different from each other on different locations of the surface of the substrate.

4. The method of claim 1, wherein the forming of the predetermined pattern by imprinting the inkjet printed material on the surface of the substrate using the imprint mold comprises:
filling the inkjet printed material on the surface of the substrate in concaved grooves of the imprint mold by pressing the imprint mold against the substrate;
forming the pattern by hardening the material; and
removing a residual film around the pattern.

5. The method of claim 4, wherein the hardening of the material comprises hardening the material by irradiating ultraviolet rays or applying heat.

6. A method of forming a pattern, the method comprising:
partially inkjet printing a material for forming the pattern in an imprint mold using an inkjet head; and
forming a predetermined pattern by imprinting the material on a surface of the substrate using the imprint mold.

7. The method of claim 6, wherein the partial inkjet printing of the material comprises partially filing the material in the concaved grooves in the pattern of the imprint mold.

8. The method of claim 6, wherein the partial inkjet printing of the material comprises inkjet printing at least two materials that are different from each other on different locations of the imprint mold.

9. The method of claim 6, wherein the forming of the predetermined pattern by imprinting the material on the surface of the substrate using the imprint mold comprises:
attaching the material inkjet printed in concaved grooves of the imprint mold to the surface of the substrate by pressing the imprint mold against the substrate;
forming the pattern by hardening the material; and
removing a residual film around the pattern.

10. The method of claim 6, wherein the hardening of the material comprises hardening the material by irradiating ultraviolet rays or applying heat.

11. A method of forming a pattern, the method comprising:
partially inkjet printing a material for forming the pattern on a reference surface using an inkjet head; and
forming a predetermined pattern by imprinting the partially inkjet printed material on a substrate using an imprint mold.

12. The method of claim 11, wherein the reference surface comprises a surface of the substrate.

13. The method of claim 11, wherein the reference surface comprises a surface of the imprint mold.

14. The method of claim 11, wherein the imprint mold comprises concave grooves to correspond to the pattern, and the reference surface comprises surfaces of the concave grooves of the imprint mold.

15. The method of claim 11, wherein the reference surface comprises a first surface and a second surface, and the material comprises a first material formed in the first surface and a second material formed in the second surface.

16. The method of claim 11, wherein the reference surface comprises a flat surface.

17. The method of claim 11, wherein the partially inkjet printed material comprises a plurality of portions spaced-apart from each other to correspond to the pattern.

18. The method of claim 11, wherein the partially inkjet printed material comprises a plurality of portions having different dimensions to correspond to a shape of the pattern.

19. An apparatus to form a pattern, comprising:
an inkjet head to partially inkjet print a material to form the pattern, on a reference surface; and
a unit having a substrate and an imprint mold to form a predetermined pattern by imprinting the inkjet printed material of the reference surface on the substrate using the imprint mold.

20. The apparatus of claim 19, further comprising:
a controller to control the inkjet head to form the partially inkjet printed material on the reference surface according to the pattern.

21. The apparatus of claim 19, further comprising:
a memory to store information on n; and
a controller to control the inkjet head to eject the material on the stored locations of the reference surface.

22. The apparatus of claim 19, wherein:
the material comprises a plurality of materials; and
the inkjet head comprises a plurality of heads to eject corresponding ones of the plurality of materials on the reference surface.

23. The apparatus of claim 19, wherein the inkjet head forms a first portion of the material at a first location of the reference surface and a second portion of the material at a second location of the reference surface.
